(19) United States
(12) Patent Application Publication
(10) Pub. No.: US 2024/0077078 A1
(43) Pub. Date: Mar. 7, 2024

(54) ROTARY VANE VACUUM PUMP WITH GAS BALLAST ASSEMBLY

(71) Applicant: Leybold (Tianjin) International Trade Co Ltd, Tianjin (CN)

(72) Inventors: Li Ouyang, Tianjin (CN); Chuanlei Yang, Tianjin (CN)

(21) Appl. No.: 18/260,346

(22) PCT Filed: Dec. 23, 2021
(86) PCT No.: PCT/IB2021/062250

§ 371 Date: Jul. 5, 2023

(30) Foreign Application Priority Data
Jan. 7, 2021 (WO) PCT/CN2021/070556

(51) Int. Cl. F04C 18/344; F04C 25/02; F04C 29/00

(52) U.S. Cl. CPC F04C 18/3441; F04C 25/02; F04C 29/0007; F04C 2220/50

(57) ABSTRACT

The present disclosure relates to a rotary vane vacuum pump 300 (300′) comprising a gas ballast assembly 330. The gas ballast assembly 330 comprises a gas ballast passage fluidly connected to a stator chamber 212 of the pump 300, a gas ballast valve 334 configured to selectively open and close the gas ballast passage depending on the relative gas pressure across the valve 334, and a gas ballast buffer chamber 360 fluidly connected to the gas ballast passage upstream of the gas ballast valve 343, which is in selective fluid communication with the exterior of the pump 300 (300′). The present disclosure also provides a related method of communicating ballast gas to a rotary vane vacuum pump 300 (300′).

### CROSS-REFERENCE OF RELATED APPLICATION

This application is a Section 371 National Stage Application of International Application No. PCT/IB2021/062250, filed Dec. 23, 2021, and published as WO 2022/149038A1 on Jul. 14, 2022, the content of which is hereby incorporated by reference in its entirety and which claims priority of Chinese Application No. PCT/CN2021/070556, filed Jan. 7, 2021.

### FIELD

This disclosure relates to a rotary vane vacuum pump. This disclosure also relates to a method of communicating ballast gas to a rotary vane vacuum pump.

### BACKGROUND

Rotary vane vacuum pumps can be used in a variety of industries to provide and maintain vacuum conditions in a system. In such pumps, working gas to be evacuated from a system is delivered to an inlet of the pump and communicated to one or a series of rotary vane pump stages. Each rotary vane pump stage features a stator defining a stator chamber therein and a rotor with radially extending vanes (i.e., a rotary vane assembly) mounted eccentrically therein. The rotary vane assembly is driven to rotate (e.g., by a motor) to compress the working gas in the stator chamber(s) and drive it to an outlet of the pump through which it is exhausted from the system.

Rotary vane vacuum pumps can be provided as “two-stage” rotary vane vacuum pumps. These pumps are so-called because they provide two stages (i.e., two sets) of stator chambers and rotary vane assemblies in serial fluid communication with each other. The first stage is fluidly connected to the pump inlet and compresses the working gas using a first rotary vane assembly in a first stator chamber (often known as a “high vacuum stage). The compressed working gas from the first stage is then delivered to a second stage, which is fluidly connected to an outlet of the first stage. The second stage features a second rotary vane assembly in a second stator chamber, and is used to compress the working gas further and drive it towards an outlet of the pump from which the working gas is exhausted from the system. Having multiple stages can increase the effectiveness and efficiency of the pump compared to a “single-stage” rotary vane vacuum pump, and can permit higher degrees of vacuum to be achieved for particular systems.

As the vanes rotate within the stator chamber, they make continuous rotating contact with the chamber surface. This can generate significant friction and heat. It is therefore necessary for the vanes to be sufficiently lubricated during operation in order for the pump to function properly and efficiently. In some known rotary vane vacuum pumps, this lubrication is achieved by providing the pump with a lubricating oil supply that is feed into the stator chambers. The oil is picked up by the rotating vanes during pump operation and forms a lubricating oil film between the chamber surface and the rotating vanes. The supply of oil is typically held and sealed within the pump itself (e.g., held within a casing of the pump surrounding the rotary vane stage(s)). Such pumps are generally known as “oil-sealed” rotatory vane vacuum pumps.

The working gas that is delivered to the rotary vane vacuum pump may contain water vapour or other volatile vapours. During the compression stage(s) in the rotary vane vacuum pump, there is a risk that these vapours may be condensed into liquid. This will generally occur if the vapours are compressed to more than their saturation vapour pressure. The condensing of vapours in this manner is problematic for such pumps, since the resulting condensate can mix with the lubricating oil in the stator chamber. This may emulsify the oil and degrade its lubricating properties. Such degradation of lubricating properties could lead to increased friction and heat during pump operation (leading to a reduction of efficiency), and can lead to seizure or failure of the pump. Such condensates could also be corrosive to the pump.

It is known to solve the problems associated with the compression of vapours by using a gas ballast device to introduce ballast gas (usually air) from outside the pump into the stator chamber leading to the pump outlet (e.g., the second/outlet pumping stage of a two-stage rotary vane vacuum pump).

The ballast gas introduced to the stator chamber dilutes the vapours to raise their saturation vapour pressure, such that the chances of them condensing during compression is minimised. The vapours and ballast gas are then exhausted from the pump with the working gas via the pump outlet.

A typical gas ballast device employs a one-way or non-return valve that can be operated to open and close during a pumping cycle to selectively introduce ballast gas into the stator chamber via a passage.

The repeated opening and closing of the valve can provide a significant source of noise, as can the continued pulses of ballast gas being pulled through the gas ballast device. It has also been found that the noise level increases as more ballast gas is introduced into the pump (e.g., due to larger openings being needed between the pump and the exterior). This has previously placed a limitation on the amount of ballast gas that can be introduced into the pump during a gas ballasting pumping cycle, whilst retaining acceptable noise levels. This can limit the maximum amount of water/volatile vapour that can be displaced by the gas ballasting operation per pumping cycling or the so-called “vapour handling capacity” provided by the gas ballast device.

Accordingly, a need exists to provide a rotary vane vacuum pump with a gas ballast assembly that improves upon these aspects. For example, to provide a rotary vane vacuum pump with reduced noise levels when operating in gas ballasting mode, and to provide a rotary vane vacuum pump with a greater flexibility and range of vapour handling capacities, whilst maintaining acceptable or reduced noise levels.

The discussion above is merely provided for general background information and is not intended to be used as an aid in determining the scope of the claimed subject matter. The claimed subject matter is not limited to implementations that solve any or all disadvantages noted in the background.

### SUMMARY

From one aspect, the present disclosure provides a rotary vane vacuum pump comprising a stator defining a stator chamber therein, a rotary vane assembly mounted for rotation eccentrically within the stator chamber, a generator casing that encases the stator, and a gas ballast assembly in fluid communication with the stator chamber for selectively admitting ballast gas from an exterior of the pump into the stator chamber. The gas ballast assembly comprises a gas ballast passage fluidly connected to the stator chamber, a gas ballast valve configured to selectively open and close the gas ballast passage depending on the relative gas pressure across the valve, and a gas ballast buffer chamber fluidly connected to the gas ballast passage upstream of the gas ballast valve, and in selective fluid communication with the exterior of the pump.

The gas ballast buffer chamber provides an enclosed volume that can be filled with ballast gas during a gas ballasting process, and so provides a ‘buffer’ of ballast gas between the gas ballast valve and the exterior of the pump. This can provide a reduction in noise associated with the operation of the gas ballast assembly.

In one embodiment of the above, the gas ballast buffer chamber is disposed outside of the stator and within the generator casing.

By locating the gas ballast buffer chamber in this manner, the total pump envelope can be kept compact, whilst still enabling sufficient space for the buffer chamber.

In a further embodiment of either of the above, the gas ballast buffer chamber is enclosed within a separate casing to the generator casing. The separate casing may be a coupling housing to which the generator casing is attached.

This provides a convenient and advantageous location for the buffer chamber to be placed, where it can be formed integrally into the coupling housing, rather than needing to be formed in a separate housing that must be sealed from oil in the generator casing (in an oil-sealed variant). The buffer chamber being in the coupling housing may also help provide a convenient location for the control element communicating therewith, which can also be fixed thereto.

In a further embodiment of any of the above, the gas ballast valve is recessed within the stator.

This provides the advantage of further insulating the noise generated by the gas ballast valve by using the stator itself. In other words, the body of the stator in which the gas ballast valve is recessed will help absorb the sound generated thereby.

In a further embodiment of any of the above, the pump further comprises
a motor assembly operatively connected to the rotary vane assembly to drive the rotary vane assembly to rotate, and a motor casing encasing the motor assembly. The motor casing is attached to the coupling housing opposing the generator casing.

This arrangement allows the motor and generator sections to be separately attached to either side of the coupling housing. This can facilitate assembly of the rotary vane vacuum pump, as well as allowing separate replacement and disassembly of each individual section.

In a further embodiment of any of the above, the gas ballast buffer chamber is fluidly connected to the gas ballast passage via a pipe disposed outside of the stator and within the generator casing. The pipe may be connected to the stator using a push-in quick connector. The connector can also connect to the stator in the recess.

These arrangements facilitate a simple and convenient way of connecting the gas ballast buffer chamber to the stator for improved ease of assembly.

In yet a further embodiment of the above, the connector itself may act as part of the gas ballast valve (e.g., a valve seat for the gas ballast valve).

This can reduce the complexity and part count of the assembly compared to arrangements that alternatively require separate valve bodies to be provided.

In yet a further embodiment of any of the above, the gas ballast assembly further comprises a gas ballast control element fluidly connected to the gas ballast buffer chamber. The control element is operable to selectively allow or prevent fluid communication between the gas ballast buffer chamber and the exterior of the pump.

In this way, the control element can be used to initiate or terminate a gas ballasting mode of pump operation. When initiated, ballast gas will be allowed to enter the stator chamber during the pumping cycle. When terminated, ballast gas will not be allowed to enter the stator chamber during the pumping cycle, which can allow a ‘normal’ mode of pump operation.

In a further embodiment of the above, the control element comprises a body including at least one orifice therein and a cover that is configured to rotate around the body to selectively open or occlude the at least one orifice to selectively allow or prevent fluid communication between the gas ballast buffer chamber and the exterior of the pump.

This arrangement provides a ‘rotary knob’ type control element, that can be conveniently operated by a user to switch between different gas ballasting modes of operation and a normal mode of operation for the pump. Such a manual control element may also remove complexity and potential failure points compared with other control elements (e.g., such as electrically controlled control elements). It may also allow a simple way of introducing additional or greater variation in vapour handling capability for the pump by providing a plurality of orifices of different sizes.

In a further embodiment of any of the above, the pump is an oil-sealed rotary vane vacuum pump, and the generator casing is an oil casing for housing oil.

In a further embodiment of any of the above, the pump is a two-stage rotary vane vacuum pump, and the stator chamber and the rotary vane assembly are fluidly connected downstream of another stator chamber and rotary vane assembly mounted for rotation eccentrically therein.

Such oil sealed and/or two stage rotary vane vacuum pumps can have reliability and heat dissipation advantages, as well as achieving potentially higher degrees of vacuum compared to other types of rotary vane vacuum pumps (e.g., dry pump or pumps with fewer stages).

From another aspect, the present disclosure provides a method of communicating ballast gas to a rotary vane vacuum pump. The method comprises the steps of: placing a gas ballast buffer chamber in selective fluid communication with a ballast gas from an exterior of the rotary vane vacuum pump; fluidly connecting a gas ballast passage and a gas ballast valve to the gas ballast buffer chamber downstream thereof, wherein the gas ballast valve is configured to selectively open and close the gas ballast passage depending on the relative gas pressure across the valve; and fluidly connecting the gas ballast passage to a stator chamber of the rotary vane vacuum pump.

As discussed above, the gas ballast buffer chamber provides an enclosed volume that can be filled with ballast gas during a gas ballasting process, and so provides a ‘buffer’ of ballast gas between the gas ballast valve and the exterior of the pump. This can provide a reduction in noise associated with the operation of gas ballast assembly.

In a further embodiment of the above, the method further comprises operating a gas ballast control element to selectively allow or prevent fluid communication between the gas ballast buffer chamber and the ballast gas from the exterior of the pump.

In this way, the control element can be used to initiate or terminate a gas ballasting mode of pump operation. When initiated, ballast gas will be allowed to enter the stator chamber during the pumping cycle. When terminated, ballast gas will not be allowed to enter the stator chamber during the pumping cycle, which can allow a ‘normal’ mode of pump operation.

In further embodiments, the method can also include using a rotary vane vacuum pump in accordance with that of the previous aspect above or any of the embodiments thereof.

Although certain advantages have been discussed in relation to certain features above, other advantages of certain features may become apparent to the skilled person following the present disclosure.

### BRIEF DESCRIPTION OF DRAWINGS

One or more non-limiting examples will now be described, by way of example only, and with reference to the accompanying figures in which:

FIG. 1 shows an exterior view of an example two-stage oil sealed rotary vane vacuum pump;

FIG. 2 shows a cross-sectional view of a known gas ballast assembly in communication with a stage of a rotary vane vacuum pump;

FIG. 3A shows an embodiment of a rotary vane vacuum pump with a gas ballast assembly in accordance with the present disclosure;

FIG. 3B shows another embodiment of a rotary vane vacuum pump with a gas ballast assembly in accordance with the present disclosure;

### DETAILED DESCRIPTION

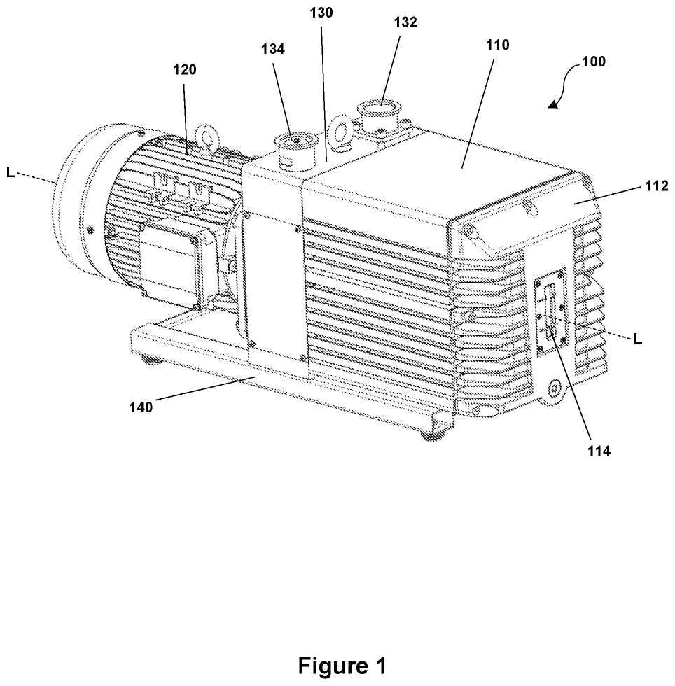

Referring to FIG. 1, a two-stage oil-sealed rotary vane vacuum pump 100 is shown with casings and a housing that are applicable to the present disclosure.

As discussed in the background above, and as generally known, the pump 100 includes two-stages of rotary vane assemblies arranged in serial fluid communication which are used to generate a vacuum in a system. These stages accordingly provide a so-called “generator” section of the pump 100.

The generator section of the pump 100 is encased in a generator casing 110. The generator casing 110 accordingly surrounds and houses the stator and the rotary vane assembly stages mounted in stator chambers defined therein.

The depicted generator casing 110 includes a removable end plate 112, which is secured in place by removable fasteners, although the generator casing 110 may instead be an integral single piece structure.

The depicted pump 100 is oil-sealed, and thus, generator casing 110 is configured to house oil, which is utilised within the stator and rotary vane assemblies for lubrication, as discussed in the background above. The housing of oil within generator casing 110 can also help to dissipate heat from the pump stages. In such oil-sealed examples, the generator casing 110 may therefore also be known as an “oil casing”.

To monitor the level and quality of oil during pump operation, a transparent oil monitoring window 114 is generally defined in the generator casing 110. Although it should be understood that the oil monitoring window 114 may be omitted in other examples.

The pump 100 also includes a motor assembly which is encased within a motor casing 120. The motor assembly is operatively connected to the rotary vane assemblies and is operated to rotate the rotary vane assemblies for pump operation. The motor assembly can include any suitable type of motor, such as an electrical motor, and associated components (e.g., rotor shaft, magnets etc.).

The pump 100 further includes a coupling housing 130 to which the generator casing 110 and motor casing 120 are attached. The generator casing 100 and motor casing 120 are mounted at opposing ends of the coupling housing 130, and extend along a longitudinal axis L-L of the pump 100. The generator and motor casings 110, 120 can be attached to the coupling housing 130 in any suitable manner, such as by using threaded fasteners.

The coupling housing 130 also includes an inlet 132 and an outlet 134 for the pump 100 that communicate working gas to be evacuated from a system into and out of the pump stages, respectively. It should be noted, however, that the inlet 132 and outlet 134 can be located elsewhere on the pump 100 depending on the application and specific pump configuration required.

The pump 100 also includes a base 140 on which the generator and motor casings 110, 120 and coupling housing 130 are mounted. Although, the base 140 may be omitted in other examples.

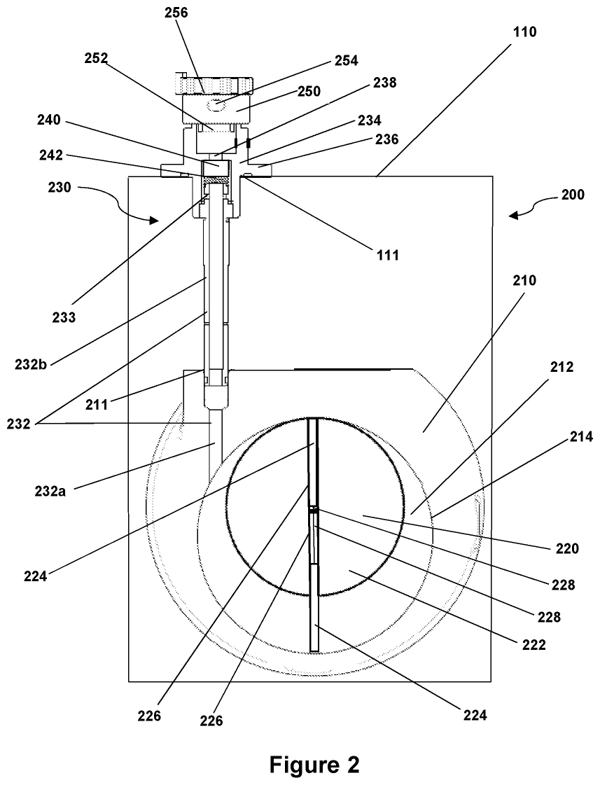

Referring to FIG. 2, a known configuration of a gas ballast assembly communicating with a stage 200 of a rotary vane vacuum pump is shown.

The rotary vane vacuum pump stage 200 includes a stator 210 that defines a stator chamber 212 therein, and which is encased within a generator casing 110. The stator chamber 212 is generally cylindrical and is delimited by a stator chamber surface 214.

The stage 200 also includes a rotary vane assembly 220 mounted eccentrically within the stator chamber 212. The rotary vane assembly 220 includes a rotor shaft 222 and a pair of diametrically opposed vanes 224 housed in respective slots 226 therein. The slots 226 extend radially from the centre of the rotor shaft 222 to its circumference. The vanes 224 are spring-loaded via biasing members 228 fixed in the slots 226 such that they are biased to extend radially from the slots 226 and make contact with the chamber surface 214.

As discussed above, in use, the rotor shaft 222 is driven to rotate e.g., by operative connection to a motor (not shown). As the shaft 222 rotates, the vanes 224 will slide along the chamber surface 214, and move radially inward and outward of the slots 226 accordingly. As is generally known in the field of rotary vane vacuum pumps and discussed in the background above, this allows working gas to be selectively admitted into the chamber 212 from an inlet (not shown), isolated and compressed between the vanes 224 co-operating with the surface 214, and then discharged from an outlet (not shown) of the stator chamber 212.

The rotary vane vacuum pump stage 200 further comprises a gas ballast assembly 230. As discussed in the background section above, the gas ballast assembly 230 is in fluid communication with the stator chamber 212 for selectively admitting ballast gas from an exterior of the pump stage 200 into the stator chamber 212.

The gas ballast assembly 230 includes a gas ballast passage 232 that is fluidly connected to the stator chamber 212. In the depicted embodiment, the passage 232 is formed of a first portion 232a that extends through the stator 210 from the chamber 212 to an opening 211 in the stator 210, and a second portion 232b in the form of a pipe that is connected to the first portion 232a at the opening 211 and extends between the stator 210 and the generator casing 110.

As will be appreciated, if the generator casing 110 is used as an oil casing and houses oil (i.e., if the stage 200 is in an oil-sealed rotary vane vacuum pump), the pipe 232b is required to provide an adequately sealed pathway for the ballast gas between the exterior of the casing 110 to the stator chamber 212 that avoids oil being communicated into the gas ballast passage 232. This can be achieved in any suitable manner, such as sealing the pipe 232b in the opening 211 using O-ring seals.

The gas ballast assembly 230 further comprises a gas ballast valve 234 disposed upstream of the passage 232. The valve 234 includes a valve body 236 that is secured in an opening 111 of the generator casing 110. The valve body 236 defines a valve seat with a valve opening 238 therein.

A valve piston 240 is disposed in the valve body 236 and is biased against the valve seat to close the valve opening 238 by a biasing member 242 (e.g., a spring or other suitable biasing member). The biasing member 242 is secured between the pipe 232b and the piston 240. The passage 232 is in selective fluid communication with the valve opening 238 via an opening 233 provided in the pipe 232b.

It will be appreciated that the valve seat opening 238 can be selectively opened by overcoming the biasing force of the biasing member 242 that is pushing the piston 240 against it e.g., by using the differential gas pressure across the piston 240. In this manner, the piston 240 can be used to selectively open and close the gas ballast passage 232 depending on the relative gas pressure thereacross.

The gas ballast assembly 230 further comprises a gas ballast control element 250 fluidly connected to the valve 234, and operable to selectively allow or prevent fluid communication between the gas ballast valve 234 and exterior of the pump stage 200. In the depicted embodiment, the control element 250 comprises a body 252 including an orifice 254 therein and a cover 256 that is configured to rotate around the body 252 to selectively open or occlude the orifice 254 to allow or prevent fluid communication between the gas ballast valve 234 and the exterior of the pump stage 200. When the cover 256 occludes the orifice 254, the valve 234 is prevented from fluid communication with ballast gas around the exterior of the pump stage 200. When the cover 256 opens the orifice 254, ballast gas from the exterior of the pump stage 200 is allowed to be fluidly communicated to the valve 234 through the body 252.

The ballast gas can be any suitable gas supplied from any suitable source. For example, the ballast gas may be ambient air supplied from the surroundings of the pump stage 200, or a different ballast gas provided from a dedicated source external to the pump stage 200 (e.g., such as Nitrogen). As will be appreciated, the particular ballast gas required will be dependent on the particular application (e.g., inert gases instead of air may be required to maintain ‘cleaner’ conditions).

As discussed in the background above, when required, the gas ballast assembly 230 can be operated to selectively admit ballast gas into the stator chamber 212 to help prevent condensation of water/volatile vapours therein.

The gas ballast assembly 230 is activated by operating the control element 250 to open the orifice 254. This allows ballast gas to enter the valve 340 at a set pressure according to the source it comes from (e.g., such as atmospheric pressure if ambient air from around the exterior of the pump stage 200 is used). If the pump stage 200 is then operated and the rotary vane assembly 220 rotated, at certain points during the pumping cycle, the gas pressure in the chamber 212 will be lower than the set pressure of the ballast gas. This gas pressure imbalance will be felt across the piston 240 in the valve 234 to overcome the biasing force of the biasing member 242 and open the valve opening 238. This allows ballast gas to flow through the gas ballast valve 240 and gas ballast passage 232 and be introduced into the stator chamber 212.

After introduction of the ballast gas into the chamber 212 and compression during the pumping cycle, the gas pressure in the chamber 212 communicating with the gas ballast passage 232 will increase above the set pressure, which will remove the driving force overcoming the biasing force on the piston 240. Accordingly, the piston 240 will close against the valve seat opening 238 and prevent further fluid communication between the valve 234 and the chamber 212. This will prevent further introduction of ballast gas into the chamber 212, as well as prevent the mixture of working gas and ballast gas in the chamber 212 being discharged through the passage 232. This mixture is instead discharged through the pump outlet (not shown).

As the pumping cycle continues and repeats so will the opening and closing of the piston 240 and introduction of ballast gas into the chamber 212.

The gas ballasting process can be stopped by operating the control element 250 to close/occlude the orifice 254 using cover 256, and prevent communication of the ballast gas to the valve 234 and the passage 232 (and thus chamber 212) during the pumping cycle.

Rotary vane vacuum pumps will often operate in excess of 1000 RPM, and during a gas ballasting process, the repeated opening and closing of the piston 240 against the valve seat opening 238 generates significant noise, as does the frequent pulses of ballast gas being pulled through the gas ballast assembly 230 (e.g., which may generate a ‘whistling’ noise).

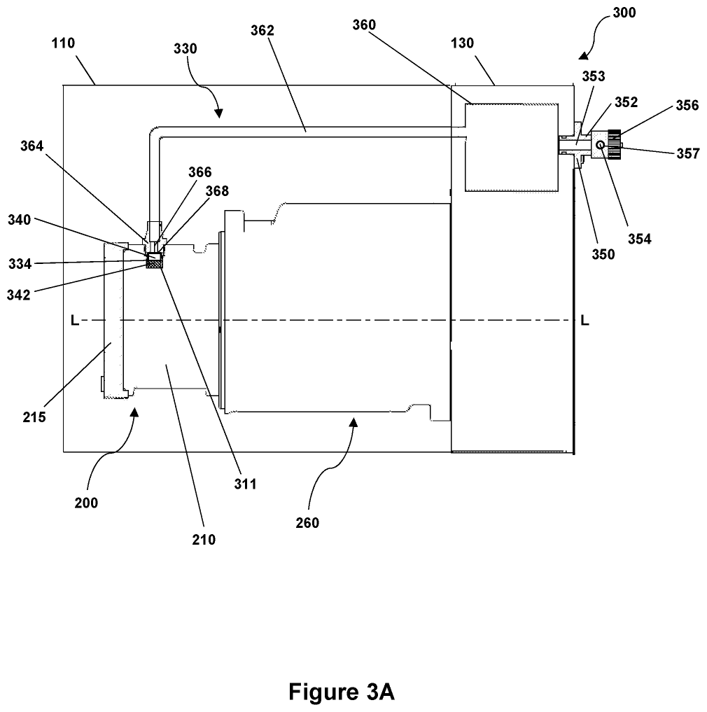

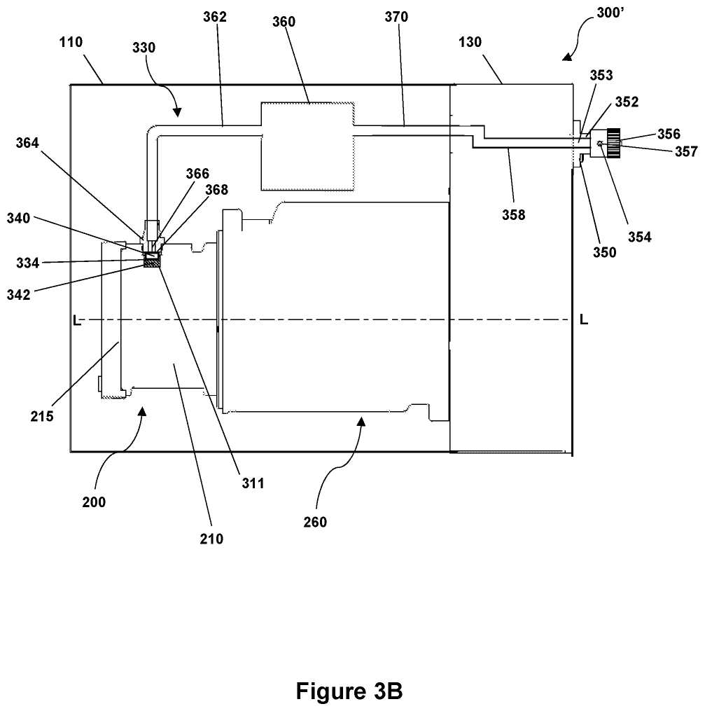

Referring to FIGS. 3A and 3B, two different embodiments of rotary vane vacuum pumps 300, 300′ in accordance with the present disclosure are shown, which aim to address the aforementioned drawbacks associated with the gas ballast assembly 230.

As discussed below, the depicted rotary vacuum vane pumps 300, 300′ include the same casing, stator and rotary vane assembly features as those of FIGS. 1 and 2, but provide a modified gas ballast assembly 330. Accordingly, like-features are given the same numerals in FIGS. 3A and 3B as in FIGS. 1 and 2, and the above description of these features when referring to FIGS. 1 and 2 applies equally to FIGS. 3A and 3B, and will not be repeated below for brevity.

The rotary vacuum vane pumps 300, 300′ are shown with the generator casing 110 and the coupling housing 130. Although not shown in FIGS. 3A and 3B, the rotary vacuum vane pumps 300, 300′ may also include any or all of the other pump and casing components discussed in relation to FIG. 1 e.g., such as end plate 112, oil monitoring window 114, motor assembly and motor casing 120, inlet 132 and outlet 134, and base 140.

The rotary vane vacuum pumps 300, 300′ include the pump stage 200 encased in the generator casing 110. The pump stage 200 includes the stator 210 and the rotary vane assembly 220 (not shown) mounted for rotation eccentrically therein. The stator 210 includes an end plate 215 fixed thereto, that seals and closes the stator chamber 212.

Although the rotary vane assembly 220 has been exemplified with a pair of vanes, slots and biasing members 224, 226, 228, it should be understood that any other suitable configuration of rotary vane assembly 220 is also envisaged within the scope of this disclosure, for example, with any suitable number of sets of vanes, slots and biasing member (e.g., three or more).

The rotary vacuum vane pumps 300, 300′ exemplify two-stage oil sealed rotary vane vacuum pumps. Accordingly, in the depicted embodiments, the generator casing 110 is used as an oil casing and houses oil. Also, a first (or “high vacuum”) pump stage 260 is placed upstream of the pump stage 200 and in fluid communication therewith. Pump stage 200 is accordingly a second, subsequent (or “low vacuum”) pump stage 200 that is downstream and fluidly connected to the output of the first stage 260. The first pump stage 260 generally includes the same stator and rotary vane assembly features as the second stage 200. As is generally known, the first stage 260 takes working gas from the pump inlet 132 and is driven to deliver it to the second stage 200, which then drives the working gas to the pump outlet 134 where it is discharged from the pump 300, 300′.

Although the rotary vane vacuum pumps 300, 300′ are exemplified as oil-sealed two-stage rotary vane vacuum pumps and the present disclosure finds particular benefit when used therein, it nevertheless finds benefit when used in other rotary vane vacuum pumps, such as rotary vane vacuum pumps with fewer or more stages and/or dry rotary vane vacuum pumps. All such suitable applications are accordingly envisaged within the scope of this disclosure.

The pumps 300, 300′ include a gas ballast assembly 330. The gas ballast assembly 330 is in fluid communication with the stator chamber 212 for selectively admitting ballast gas from an exterior of the pumps 300, 300′ into the stator chamber 212. The gas ballast assembly 330 comprises a gas ballast passage (not shown) similar to the first portion 232a of the gas ballast passage 232 that is fluidly connected to the stator chamber 212. The gas ballast passage is defined in and passes through the stator 210 and opens into the stator chamber 212 at one end and is in fluid communication with a gas ballast valve 334 at the other end.

The gas ballast valve 334 is configured to selectively open and close the gas ballast passage depending on the relative gas pressure across the valve 334. The depicted gas ballast valve 334 features a similar piston 340 and biasing member 342 arrangement to that of FIG. 2.

The stator 210 defines a recess 311 therein (i.e., defined in the outer surface of the stator body) within which the gas ballast valve 334 is disposed. In this manner, the gas ballast valve 334 (and in particular its moving parts (i.e., piston 340) is recessed within the stator 210.

The gas ballast assembly 330 further comprises a fluid conduit 362 in the form of a pipe that is connected to the stator 210 via a push-in quick connector 364 that is inserted in the recess 311. The push-in quick connector 364 includes a passage 366 there through that opens at an end of the connector 364 and is in fluid communication with the conduit 362. The end of the connector 264 forms a valve seat 368 secured in the recess 311, against which the piston 340 is biased by the biasing member 342. In this manner, as explained in more detail below, the fluid conduit 362 is placed into selective fluid communication with the gas ballast passage and the stator chamber 212 via the valve 334.

As will be appreciated, a push-in quick connector 364 provides a convenient means to attach the fluid conduit 362 to the stator 210, as the fluid conduit 362 can be simply inserted into the connector 364 and locked in place. The connector 364 can be secured in the recess 311 by a press fit or other mechanism (e.g., complementary threaded portions).

Nonetheless, although the depicted connector 364 is a push-in quick connector, any other suitable connector could be used instead. For example, such as a threaded collar connector or permanent connector attached to the conduit 362.

The gas ballast assembly 330 further comprises a gas ballast buffer chamber 360 disposed upstream of the gas ballast valve 334 and in selective communication with the exterior of the pumps 300, 300′.

The buffer chamber 360 is connected to fluid conduit 362, such that it is fluidly connected to the gas ballast passage via the gas ballast valve 334.

The gas ballast buffer chamber 360 is an enclosed volume (or cavity) that receives ballast gas entering the gas ballast assembly 330 via a gas ballast control element 350 during a gas ballasting process/mode of pump operation.

In FIG. 3A, the gas ballast buffer chamber 360 is an enclosed volume defined within a portion of the coupling housing 130. In one example, the buffer chamber 360 is an integral cavity of the coupling housing 130 that is machined therein. In another example, the buffer chamber 360 is provided by a receptacle/distinct housing disposed within the coupling housing 130.

In FIG. 3B, the gas ballast buffer chamber 360 is an enclosed volume defined in a separate housing (or receptacle) that is disposed within a portion of the generator casing 110, instead of the coupling housing 130. In this example, the buffer chamber 360 is disposed in the oil held in the casing 110.

In either embodiment, it is to be noted that the buffer chamber 360 is disposed outside of the stator 210 but within the casings that define the exterior of the pumps 300, 300′.

In both FIGS. 3A and 3B, the control element 350 is fixed to the coupling housing 130 and in fluid communication with the exterior of the pump 300, 300′. The control element 350 is similar to the control element 250 of FIG. 2, featuring a body 352 with a passage 353 and at least one orifice 354 defined therein, and a cover 356 that is rotatably mounted around the body 352. The cover 356 features an orifice 357 therein that aligns with and is larger than the at least one orifice 354. The cover 356 can be rotated around the body 352 to selectively open or occlude the at least one orifice 354 by aligning or misaligning the orifice 357 therewith. This allows or prevents fluid communication between the passage 353 and the exterior of the pumps 300, 300′.

In FIG. 3A, the passage 353 opens to the buffer chamber 360 in the coupling housing 130, and thus allows the delivery of ballast gas from the exterior of the pump 300 to the buffer chamber 360 via the control element 350.

In FIG. 3B, the passage 353 opens to a passage 358 defined in the coupling housing 130, which is connected to another fluid conduit 370 in the generator casing 110 that subsequently connects to the gas ballast buffer chamber 360.

Although FIGS. 3A and 3B show the gas ballast buffer chamber 360 connected directly to fluid conduits 362 and/or 370 they may be connected to the gas ballast buffer chamber 360 in any suitable manner, such as through the use of any suitable connectors, such as push-in quick connectors (i.e., similar to connector 364 at the other end of conduit 362).

In either embodiment, the control element 350 can accordingly be operated to allow the communication of ballast gas from the exterior of the pump to the buffer chamber 360, and then downstream to the valve 334. During the pumping cycle in a gas ballasting mode, when the relative gas pressure within the stator chamber 212 is lower than that in the buffer chamber 360, the differential gas pressure across the valve 334 will drive the piston 340 away from the seat 368, to selectively allow ballast gas to communicate through the connector passage 366 to the gas ballast passage and be delivered to the stator chamber 212.

Accordingly, it will be understood that the gas ballast assembly 330 operates in a similar manner to that of gas ballast assembly 230. However, it differs in that a gas ballast buffer chamber 360 is added upstream of the valve 334 between the control element 350 and the valve 334, and in that valve 334 is formed at the connection to the stator 210 and is recessed therein, rather than being formed at the generator casing 110.

It has been found that by providing the gas ballast buffer chamber 360 upstream of the gas ballast valve 334, the noise associated with the gas ballasting process can be significantly reduced, and the vapour handling capacity of the pumps 300, 300′ can be increased. It is thought this is because the buffer chamber 360 provides an additional enclosed volume of ballast gas that will be held within the pump during the gas ballasting process, which can insulate the noise generated from the valve 324 downstream thereof and help modulate the ballast gas drawn into the pump 300, 300′. In other words, the buffer chamber 360 provides as an effective ‘buffer’ of ballast gas between the valve 334 and the control element 350.

The gas ballast buffer chamber 360 provides a greater enclosed volume compared than that of the control element passage 253 and the at least one orifice 254. However, it is to be understood that the particular size and shape of the gas ballast buffer chamber 360 can be readily varied according to the vapour handling and noise characteristics of a particular application and gas ballasting operation.

Moreover, the locating of the valve 334 itself in the stator 210 (i.e., away from the generator casing 110), and further recessing it therein, is thought to also improve the insulation of the noise generated thereby. This is because it allows the body of the stator to absorb some of the noise, and gives the noise further to travel and be dissipated before reaching the exterior of the pump. Furthermore, in the depicted oil-sealed example, the oil around the stator 210 is also thought to help further insulate the noise generated by the valve 334.

Although the depicted embodiment is particularly advantageous, it should also be understood that within the scope of the present disclosure alternative configurations are available, and will still benefit from the gas ballast buffer chamber 360 being added upstream of the gas ballast valve 334. For example, in other configurations, the recess 311 may be omitted, and the valve 334 may be located elsewhere in the pumps 300, 300′ relative to the stator 210.

As discussed above, the control element 350 includes at least one orifice 354. In some examples, the control element 350 will include a plurality of orifices 354, such as two, three or more orifices. Each of the orifices 254 can be a different size and only one will be exposed to the cover orifice 357 at a time. The size of the orifices 354 can be varied to vary the amount of ballast gas introduced during each pump cycle during a gas ballasting process. As will be appreciated, this variation in orifice size can be used to adjust the vapour handling capability of the rotary vane vacuum pumps 300, 300′ (i.e., adjust the amount of water/volatile vapour that can be effectively diluted during each pump cycle).

Since the disclosed pumps 300, 300′ are quieter than known arrangements, it is thought that larger orifices and greater numbers of orifices can be utilised, without negatively impacting the noise characteristics of the pump during the gas ballasting process. This can lead to improvements in the maximum amount of a vapour handling in the pumps 300, 300′, as well as offer greater flexibility in the vapour handling capability of the pumps 300, 300′, such that it can be better adjusted to suit the amounts and types of vapours encountered across different applications.

Although one type of valve 334 (including a piston 340 being biased against a valve seat 368 by a biasing member 342) is shown, it should be understood that any other suitable type or configuration of one-way or non-return valve that can selectively open and close the gas ballast passage depending on the relative gas pressure across the valve may be used within the scope of this disclosure.

Similarly, although one type of control element 350 is shown (in the form of a “rotary knob” type element), any other suitable type or configuration of control element can be used within the scope of this disclosure. In one example, the control element could instead be a solenoid controlled opening that is electrically operated.

Moreover, although two particular arrangements of fluid conduits 362, 370 (and passage 358) are shown (e.g., with certain straight sections and bends) the present disclosure is not limited to such arrangements. Indeed, within the scope of this disclosure any other suitable arrangement and configuration of fluid conduits, pipes and/or passages that allow fluid communication from the control element 350 to the valve 343 via the buffer chamber 360 can be used.

1. A rotary vane vacuum pump comprising:
a stator defining a stator chamber therein;
a rotary vane assembly mounted for rotation eccentrically within the stator chamber;
a generator casing that encases the stator; and
a gas ballast assembly in fluid communication with the stator chamber for selectively admitting ballast gas from an exterior of the pump into the stator chamber;
wherein the gas ballast assembly comprises:
a gas ballast passage fluidly connected to the stator chamber;
a gas ballast valve configured to selectively open and close the gas ballast passage depending on the relative gas pressure across the valve; and
a gas ballast buffer chamber fluidly connected to the gas ballast passage upstream of the gas ballast valve, and in selective fluid communication with the exterior of the pump.

2. The rotary vane vacuum pump of claim 1, wherein the gas ballast buffer chamber is disposed outside of the stator and within the generator casing.

3. The rotary vane vacuum pump of claim 1, wherein the gas ballast valve is recessed within the stator.

4. The rotary vane vacuum pump of claim 1, wherein the gas ballast buffer chamber is enclosed within a separate casing to the generator casing.

5. The rotary vane vacuum pump of claim 4, wherein the separate casing is a coupling housing to which the generator casing is attached.

6. The rotary vane vacuum pump of claim 4, wherein the pump further comprises:
a motor assembly operatively connected to the rotary vane assembly to drive the rotary vane assembly to rotate; and
a motor casing encasing the motor assembly, wherein the motor casing is attached to the coupling housing opposing the generator casing.

7. The rotary vane vacuum pump of claim 1, wherein the gas ballast buffer chamber is fluidly connected to the gas ballast passage via a pipe disposed outside of the stator and within the generator casing.

8. The rotary vane vacuum pump of claim 7, wherein the pipe is connected to the stator using a push-in quick connector.

9. The rotary vane vacuum pump of claim 1, further comprising a gas ballast control element fluidly connected to the gas ballast buffer chamber, and operable to selectively allow or prevent fluid communication between the gas ballast buffer chamber and the exterior of the pump.

10. The rotary vane vacuum pump of claim 9, wherein the control element comprises a body including at least one orifice therein and a cover that is configured to rotate around the body to selectively open or occlude the at least one orifice to selectively allow or prevent fluid communication between the gas ballast buffer chamber and the exterior of the pump.

11. The rotary vane vacuum pump of claim 1, wherein the pump is an oil-sealed rotary vane vacuum pump, and the generator casing is an oil casing for housing oil.

12. The rotary vane vacuum pump of claim 1, wherein the pump is a two-stage rotary vane vacuum pump, and the stator chamber and the rotary vane assembly are fluidly connected downstream of another stator chamber and rotary vane assembly mounted for rotation eccentrically therein.

13. A method of communicating ballast gas to a rotary vane vacuum pump, the method comprising:
placing a gas ballast buffer chamber in selective fluid communication with a ballast gas from an exterior of the rotary vane vacuum pump;
fluidly connecting a gas ballast passage and a gas ballast valve to the gas ballast buffer chamber downstream thereof, wherein the gas ballast valve is configured to selectively open and close the gas ballast passage depending on the relative gas pressure across the valve; and
fluidly connecting the gas ballast passage to a stator chamber of the rotary vane vacuum pump.

14. The method of claim 13, further comprising operating a gas ballast control element to selectively allow or prevent fluid communication between the gas ballast buffer chamber and the ballast gas from the exterior of the pump.

15. The method of claim 13, wherein the rotary vane vacuum pump further comprises:
a stator defining the stator chamber therein;
a rotary vane assembly mounted for rotation eccentrically within the stator chamber; and
a generator casing that encases the stator.
